(19) United States
(12) Patent Application Publication
(10) Pub. No.: US 2008/0105474 A1
(43) Pub. Date: May 8, 2008

(54) CART AND CONTAINER CLEANING SYSTEM WITH HEATED FLUID

(75) Inventors: Ernest F. Byers, Albuquerque, NM (US); Dusty J. Erven, Albuquerque, NM (US); Ken Godana, Albuquerque, NM (US)

Correspondence Address: PEACOCK MYERS, P.C., 201 THIRD STREET, N.W., SUITE 1340, ALBUQUERQUE, NM, 87102, US

(73) Assignee: BLAST N CLEAN LLC, Albuquerque, NM (US)

(21) Appl. No.: 11/929,486

(22) Filed: Oct. 30, 2007

Related U.S. Application Data
(63) Continuation-in-part of application No. 11/697,208, filed on Apr. 5, 2007.
Application No. 11/697,208 is a continuation-in-part of application No. 11/681,717, filed on Mar. 2, 2007, now abandoned.
Application No. 11/681,717 is a continuation-in-part of application No. 11/458,358, filed on Jul. 18, 2006.
Application No. 11/681,717 is a continuation-in-part of application No. 11/212,276, filed on Aug. 25, 2005, now Pat. No. 7,225,816.
(60) Provisional application No. 60/604,539, filed on Aug. 25, 2004.

(51) Int. Cl. B65F 7/00; B05B 13/00; F28F 99/00

(52) U.S. Cl. 180/53.8; 239/13; 165/138

(57) ABSTRACT

The present invention relates to a mobile or stationary waste container cleaning system used for residential, commercial and industrial waste, garbage, trash, storage or operations containers or receptacles. Other applications include, but are not limited to cleaning of chemical drums, grease dumpsters (e.g. behind restaurants), rain barrels and non-uniform residential, commercial or industrial dumpsters or waste containers. The container cleaning system can alternatively be used for rural areas, farms or ranches. The system uses heat exchange to heat the fluid used for spraying and cleaning the containers.

### CROSS-REFERENCE TO RELATED APPLICATIONS

This application is a continuation-in-part of U.S. patent application Ser. No. 11/697,208 entitled “Automatic Cart and Container Cleaning and Valve System,” filed Apr. 5, 2007; which is a continuation application of U.S. patent application Ser. No. 11/681,717 entitled “Automatic Cart and Container Cleaning and Valve System,” filed Mar. 2, 2007 (abandoned); which is a continuation-in-part application of U.S. patent application Ser. No. 11/458,358, entitled “Automated Cart and Container Cleaning System,” filed on Jul. 18, 2006; which is a continuation-in-part application of U.S. patent application Ser. No. 11/212,276, entitled “Waste Container Cleaning System,” filed on Aug. 25, 2005, issued as U.S. Pat. No. 7,225,816, which claims priority to U.S. Provisional Patent Application Ser. No. 60/604,539, entitled “Mobile Waste Can Cleaning System,” filed on Aug. 25, 2004.

### BACKGROUND OF THE INVENTION

1. Field of the Invention (Technical Field)

The present invention relates to a container cleaning system preferably used for residential and commercial waste, garbage, or trash containers, carts or receptacles, and which provides a heated fluid.

2. Description of Related Art

Residential and commercial waste containers can collect wastes and pests throughout the course of their use. Cleaning and maintenance of these waste containers can be time consuming and difficult, not to mention dangerous depending on the waste or residue. Often these containers are not cleaned regularly which can lead to worse health and environmental problems, especially in areas of dense populations.

The present invention provides a heated fluid and system for cleaning the containers.

### BRIEF SUMMARY OF THE INVENTION

The present invention relates to a waste container cleaning system to provide a sanitary, efficient and cost effective apparatus and method for preferably spraying, with a heated fluid and system, residential and commercial and industrial garbage containers.

The preferred embodiment of the present invention is described in the following discussion. The present invention relates to a mobile cart or container spraying system comprising: a vehicle comprising: an engine; a transportable base comprising thereon at least one fluid spray system for spraying the cart or container with a fluid; and a heat exchange system disposed near said engine of said vehicle and said fluid spray system for heating the fluid.

The heat exchange system comprises heat exchange coils and is preferably disposed near a radiator of said vehicle. The transportable base can also have a fluid storage tank for the fluid disposed thereon.

The present invention preferably has a conveyance system comprising a conveyance pump and piping; a loading arm or tipping system for lifting and inverting the container over said spray system and setting the container back down; and a fluid recycling system

The vehicle of the present invention can preferably comprise a modified garbage truck.

The method of the present invention is preferably related to heating a fluid for spraying a cart or container on a transportable base driven by a vehicle with an engine comprising the steps of: running the vehicle engine; spraying the cart or container with a fluid from a fluid spray system; and heat exchanging the fluid from the running engine to the fluid spray system and thereby heating the fluid.

The method includes but is not limited to heat exchanging is done via heat exchange coils. The method preferably comprises disposing a heat exchange system near a radiator of the vehicle; storing the fluid on the transportable base; pumping the fluid; and recycling the fluid. The present invention preferably includes but is not limited to heating the fluid to between approximately 120° F. and 180° F.

The method of the present invention also preferably comprises the step of loading or tipping and inverting the container over the spray system and setting the container back down. The vehicle of the present invention is preferably a modified garbage truck.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a side view of an embodiment of the invention on a modified garbage truck or other vehicle;

FIG. 2 is a side view of an inverted waste container over a waste container cleaning system;

FIG. 3 is a top view schematic of an embodiment of the invention;

FIG. 4 is a side view of a front loading embodiment of the invention;

FIG. 5 is a side view of a rear loading embodiment of the present invention.

FIG. 6 is a top view of a side loading embodiment of the invention showing radiant heating coils, a solenoid, shut-off switch, a pop-off switch and a head protector;

### DETAILED DESCRIPTION OF THE INVENTION

The waste container cleaning which is preferably used to clean residential (e.g. 35 gallons to 350 gallons) or commercial or industrial (e.g. 1 cubic yard to 10 cubic yards) garbage containers. Embodiments of the invention can be used for either residential, commercial or industrial waste containers. The cleaning system preferably comprises a mobile system, including but not limited to a truck or vehicle separate from the regularly scheduled garbage truck. The waste container cleaning system is preferably a mobile vehicle with an engine, but can be stationary. The mobile system is preferably a separate modified garbage truck or other vehicle. The vehicle is preferably a side loading truck but alternatively may be a front loading truck or a rear loading truck or vehicle.

An embodiment of the invention is a side loading vehicle with a side loading arm that has been modified to invert a waste container 180 degrees. Alternatively, the waste container is inverted to less than 180 degrees, but preferably more than 150 degrees. The cleaning cycle is preferably several seconds (between approximately 6 seconds and approximately 15 seconds) and most preferably less than six (6) seconds so that the vehicle is able to follow a garbage truck along a regularly scheduled route and clean the waste containers after being dumped by the garbage truck.

As used throughout the specification and claims the terms “carts” “containers” or “garbage containers” is intended to include any residential, commercial or industrial apparatus or device which is capable of containing waste materials, debris or other items, and includes but is not limited to a receptacle, trash container, industrial container, garbage can, cart, and dumpster.

As used throughout the specification the term “pests” is intended to include any materials or organisms that may corrupt the container, including but not limited to fungi, bacteria, and odors.

The term “filter” as used throughout the specification and claims is defined as a separator and includes but is not limited to materials, electronics, or any item that is appropriate to separate one component from another.

As used throughout the specification and claims the term “fluid” is intended to include any fluid material, including but not limited to a solid, semi-solid, powder, liquid or vapor. A fluid also includes but is not limited to cold fluid, hot fluid, steam, chemicals, liquids, solids, semi-solids, gases, chemicals, oils, granules and sprays.

As used throughout the specification and claims the term “detergent” means a soap or cleaning substance and also may comprise any antibacterial, antiviral, and/or sanitary agent.

As used throughout the specification and claims, the term “guide” refers to but is not limited to anything which helps to direct the course or determine the direction of traveling of the waste container over the spray system so that the spray system is not damaged.

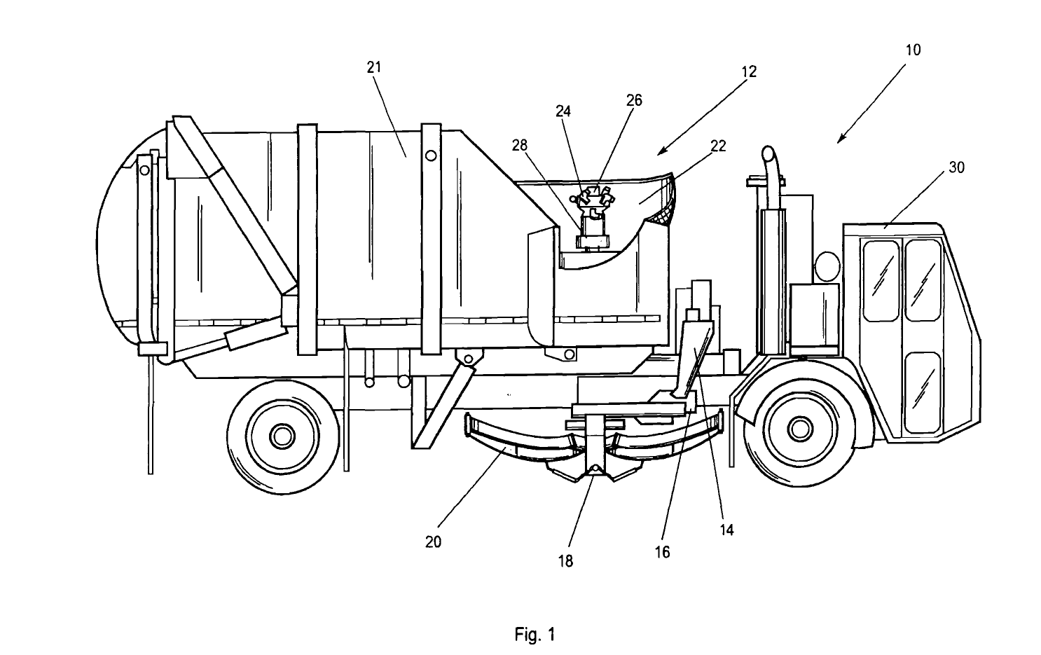

The drawings show alternative embodiments of the invention. As show therein, FIG. 1 is a side view of an embodiment of the invention. Vehicle 10 is preferably a vehicle or modified garbage truck where containment shell 21 has been “hollowed” and modified to fit in the system components. A portion of containment shell 21 has been cut away 12 in the area of the front of the truck, behind the cab, which preferably houses the front portion of the cleaning system. Preferably, a driver in cab 30 sees a waste container on a curb and pulls up next to the curb. The driver preferably operates arm 14, 16 and knuckle 18, 20 remotely through a system control box inside of cab 30. Once extended the driver uses arm 14, 16 and knuckle 18, 20 to grab, lift and invert the waste container over the front portion of the cleaning system. The inverted container is spray cleaned with a fluid and then the operator sets down the waste container using arm 14, 16 and knuckle 18, 20.

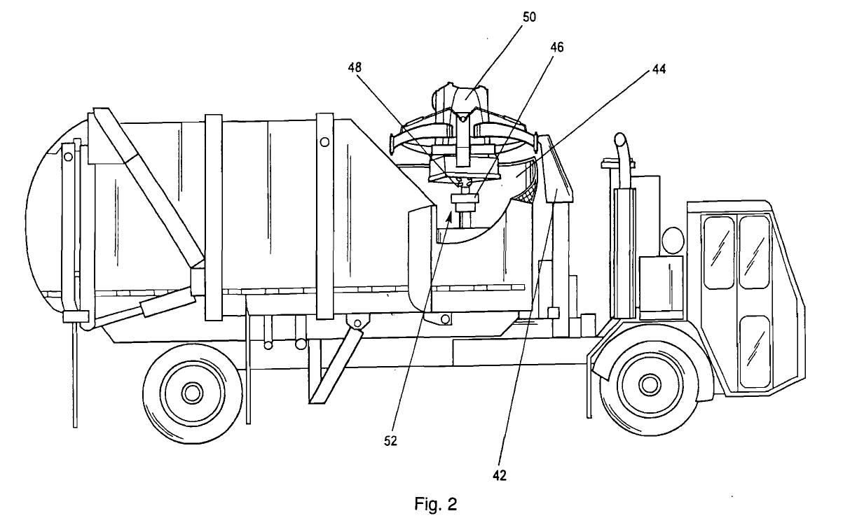

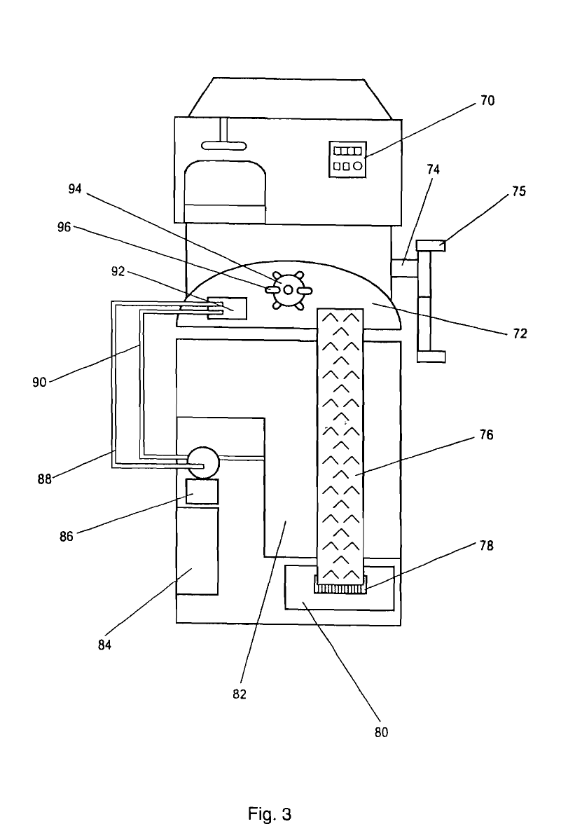

FIG. 1 also shows a spray cleaning system of the invention which includes but is not limited to hopper or catch basin 22, and directional spray nozzles 24 disposed on spray head 26 which is disposed on rotatable coupling 28. FIG. 1 shows the complete spray cleaning system which is an in-series water system. FIGS. 2-3 show additional views of the spray cleaning system and its components.

FIG. 2 shows inverted waste container 50 over the spray cleaning system. Spray system 52 preferably includes rotating coupling 46. Coupling 46 is preferably made of metal(s) including but not limited to brass and stainless steel, or other heavy duty materials, with internal seals and bearings. A stationary coupling may be used as an alternative to the preferred rotatable coupling 46. Catch basin 44 holds fluids. Lifting system 42 lifts and inverts the waste container and returns it to its approximate original position.

An embodiment of the present invention has a fluid recycling system and uses the method of recycling the fluid from the spray system after the inverted waste container has been sprayed. The fluid is preferably recycled and reused in the cleaning system. At the end of the day or run, the recycled fluid is preferably filtered and may be dumped down a sewer system and any residue or waste may be dumped at the end of the day. The filter is preferably a screen filter, and an embodiment includes but is not limited to intake and effluent valves that are used to intake fluid into the clean storage basin and remove the waste fluids and a system exhaust vent. The fluid recycling system includes but is not limited to a catch basin for catching fluid used during the spray cleaning; a filtering and separating mechanisms to separate cleaned or recyclable fluids from final waste fluids; mechanisms for reintroducing the cleaned fluid back into the clean fluid storage tank; and associated piping and pumping devices.

FIG. 3 is a top view schematic diagram of a container cleaning system. The container cleaning system, preferably includes (from front to back) catch basin 72, spray head 94, directional spray nozzles 96 preferably disposed on a rotating coupling, filter area and fluid level sensor 92, suction waste fluid removal piping 88, clean fluid intake piping 90, pump 86, power source 84, clean fluid storage tank 82, conveyor 76, conveyor brush 78 and residue bin 80. The driver preferably uses control box 70 to activate pump 86. Pump 86 is preferably idling until the driver activates it. Once activated, preferably through switching box 70, the fluid, preferably clean or grey fluid, is preferably pumped from clean fluid storage tank 82 through a valve. FIG. 3 also shows arm 74 and knuckle 75 for lifting, inverting and setting down the container. As the container is inverted (preferably approximately 180 degrees, but at least more than 150 degrees) it is positioned over directional spray nozzles 96 (e.g. see FIG. 3) which clean, rinse and sanitize the garbage container.

The preferred embodiment has an automated loading arm. Alternative embodiments include any manual, semi-automatic, and automated lifting and tipping mechanisms. Other alternatives include, but are not limited to, cylindrical, chain, and frame rail, cable, track and gear, pneumatic, and screw drive lifting mechanisms.

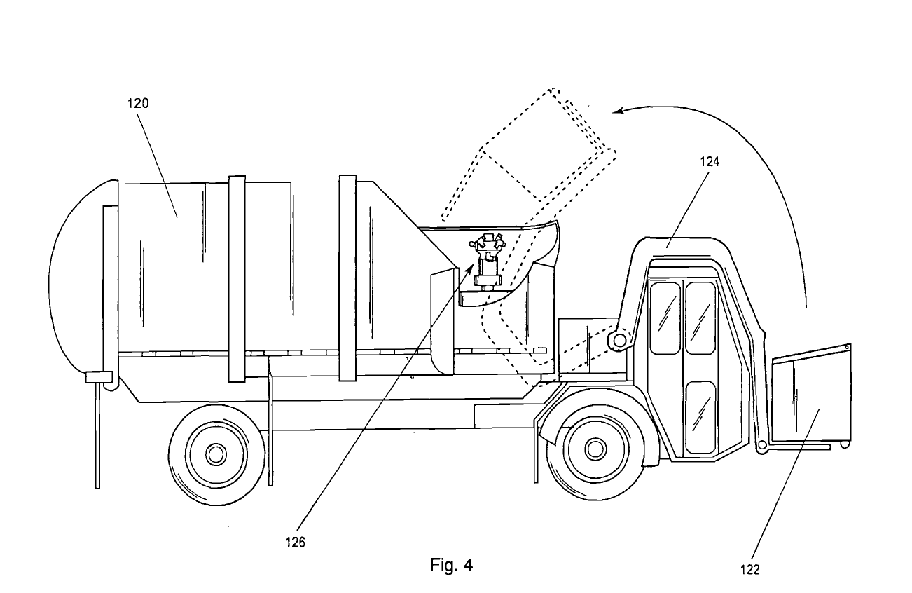

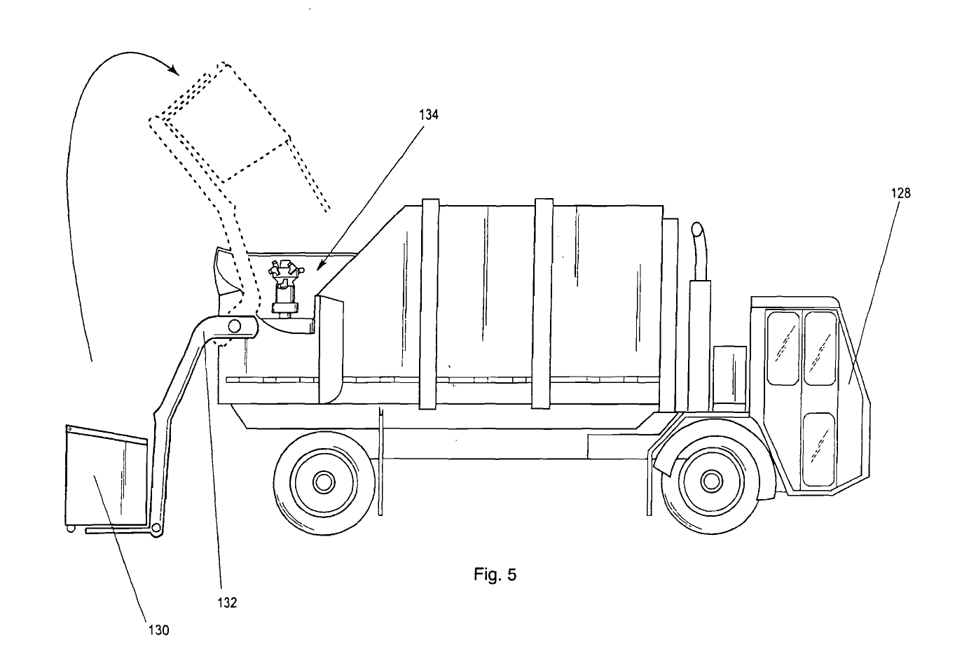

FIGS. 4 and 5 show alternative embodiments of the present invention. FIG. 4 shows front loading truck 120 with front loading arm 124 loading commercial type waste container 122 over spray cleaning system 126. FIG. 5 shows rear loading truck 128 with rear loading arm 132 loading commercial type waste container 130 over spray cleaning system 134. Alternatively, the back of the truck may be enclosed and other types of arms or lifting systems may be employed.

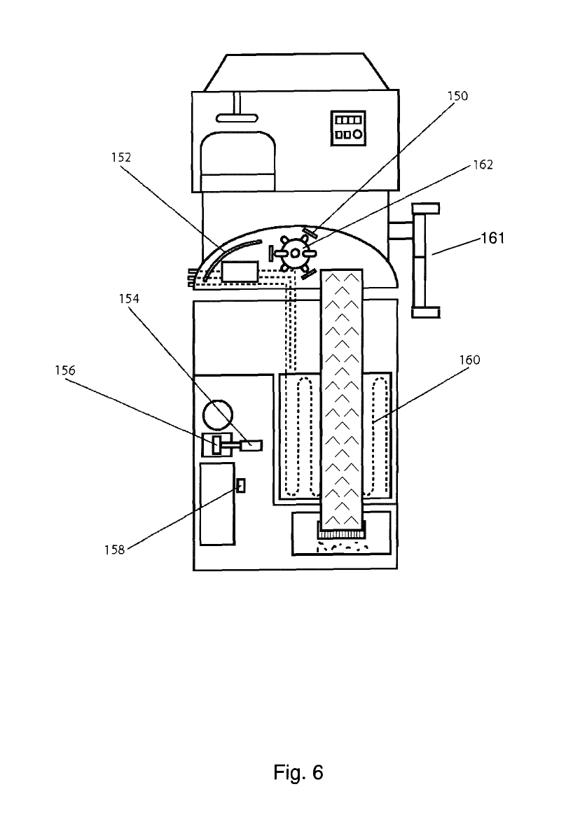

FIG. 6 is a top view of a container cleaning system(s) of the present invention showing cleaning fluid heating. Radiant heating coils are preferably placed internally to the system to act as a heating mechanism for the fluid.

Spray head or spray system 162 sprays the container and preferably has at least one nozzle. The present invention preferably uses a coil heat exchanger to heat the water for spraying. Heating coils 160 for countercurrent heat exchange, include, but are not limited to, radiator coils that enter the engine of the vehicle.

Alternative embodiments for heating the fluid include but are not limited to a flash heater, chemical reactants, and spot heating mechanisms. Heating coils 160 provide heat exchange to heat the fluid. One embodiment uses a cold water spray system. Another embodiment uses a heated fluid system. Alternative embodiments include hot water or steam systems, and mist systems that can recapture the mist for reuse.

The container cleaning system is preferably mobile. Alternatively the cleaning system may be part of a garbage truck, a separate trailer or a single person mobile unit. A number of alternative embodiments are available with slight modifications to the system. The cleaning system may alternatively be employed as a stationary cleaning system at, for example, a transfer station, landfill, toxic or hazardous waste sites or active storage units, and at remediation sites.

Other alternative uses include, but are not limited to, cleaning or spraying of chemical drums, grease dumpsters (e.g. behind restaurants), rain barrels and non-uniform residential, commercial or industrial dumpsters or waste containers. The container spraying system can alternatively be used for rural areas, farms or ranches.

### INDUSTRIAL APPLICABILITY

The invention is further illustrated by the following non-limiting examples.

### EXAMPLE 1

A system was built in accordance with the description of the invention herein. Radiator fluid was piped from the radiator through the tank to heat the cleaning solution. The solution was heated to approximately between 120° F. to 180° F.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents.

What is claimed is:

1. A mobile cart or container spraying system comprising:
a vehicle comprising:
an engine;
a transportable base comprising thereon at least one fluid spray system for spraying the cart or container with a fluid; and
a heat exchange system disposed near said engine of said vehicle and said fluid spray system for heating the fluid.

2. The system of claim 1 wherein said heat exchange system comprises heat exchange coils.

3. The system of claim 1 wherein said heat exchange system is disposed near a radiator of said vehicle.

4. The system of claim 1 wherein said transportable base further comprises a fluid storage tank for the fluid disposed thereon.

5. The system of claim 5 further comprising a conveyance system comprising a conveyance pump and piping.

6. The system of claim 1 further comprising a loading arm or tipping system for lifting and inverting the container over said spray system and setting the container back down.

7. The system of claim 1 further comprising a fluid recycling system.

8. The system of claim 1 wherein said vehicle comprises a modified garbage truck.

9. A method of heating a fluid for spraying a cart or container on a transportable base driven by a vehicle with an engine comprising the steps of:
running the vehicle engine;
spraying the cart or container with a fluid from a fluid spray system; and
heat exchanging the fluid from the running engine to the fluid spray system and thereby heating the fluid.

10. The method of claim 10 wherein the heat exchanging is done via heat exchange coils.

11. The method of claim 10 comprising disposing a heat exchange system near a radiator of the vehicle.

12. The method of claim 10 further comprising storing the fluid on the transportable base.

13. The method of claim 10 comprising pumping the fluid.

14. The method of claim 10 further comprising the step of loading or tipping and inverting the container over the spray system and setting the container back down.

15. The method of claim 10 further comprising recycling the fluid.

16. The method of claim 10 wherein the vehicle is a modified garbage truck.

17. The method of claim 10 wherein the step of heating the fluid comprises heating the fluid to between approximately 120° F. and 180° F.
